(19) United States
(12) Patent Application Publication
(10) Pub. No.: US 2015/0334349 A1
(43) Pub. Date: Nov. 19, 2015

(54) SELECTIVE TELECONFERENCE OR VIDEOCONFERENCE REPLAY FOR FUTURE PARTICIPANTS IN A GIVEN SESSION

(71) Applicant: International Business Machines Corporation, Armonk, NY (US)

(72) Inventors: Wendell J. Bouknight, JR., Clayton, NC (US); Erik W. Hochstedt, Holly Springs, NC (US); Thai T. La, Raleigh, NC (US); Dana L. Price, Surf City, NC (US)

(21) Appl. No.: 14/603,714

(22) Filed: Jan. 23, 2015

Related U.S. Application Data
(63) Continuation of application No. 14/281,034, filed on May 19, 2014.

(51) Int. Cl. H04N 7/15; H04N 5/91

(52) U.S. Cl. CPC H04N 7/155; H04N 5/91

(57) ABSTRACT

A method to provide an audio message or a visual message to at least one participant within a plurality of participants upon joining a live teleconference or a live videoconference is provided. The method may include determining a critical piece of information that needs to be shared with the plurality of participants joining the live teleconference or the live videoconference, wherein the critical piece of information is associated with the live teleconference or the live videoconference. The method may further include recording the critical piece of information as the audio message or the visual message in real-time during the live teleconference or the live videoconference. The method may further include replaying the audio message or the visual message to the at least one participant upon the at least one participant joining the live teleconference or the live videoconference.

### FIELD OF THE INVENTION

The present invention relates generally to the field of computing, and more particularly to teleconferencing and videoconferencing.

### BACKGROUND

In a teleconference or videoconference session, there is often critical information that may need to be known by all participants. The critical piece of information may include e-meeting links, time changes, updated information, etc. However, the meeting may start and the critical piece of information may be shared before all attendees join the session. As such, the meeting may be delayed while the information is shared over and over again as new people join the meeting, or meeting attendees may miss the important information entirely.

### SUMMARY

According to one embodiment, a method to provide an audio message or a visual message to at least one participant within a plurality of participants upon joining a live teleconference or a live videoconference is provided. The method may include determining a critical piece of information that needs to be shared with the plurality of participants joining the live teleconference or the live videoconference, wherein the critical piece of information is associated with the live teleconference or the live videoconference. The method may also include recording the critical piece of information as the audio message or the visual message in real-time during the live teleconference or the live videoconference. The method may further include replaying the audio message or the visual message to the at least one participant upon the at least one participant joining the live teleconference or the live videoconference.

According to another embodiment, a computer system to provide an audio message or a visual message to at least one participant within a plurality of participants upon joining a live teleconference or a live videoconference is provided. The computer system may include one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method. The method may include determining a critical piece of information that needs to be shared with the plurality of participants joining the live teleconference or the live videoconference, wherein the critical piece of information is associated with the live teleconference or the live videoconference. The method may also include recording the critical piece of information as the audio message or the visual message in real-time during the live teleconference or the live videoconference. The method may further include replaying the audio message or the visual message to the at least one participant upon the at least one participant joining the live teleconference or the live videoconference.

According to yet another embodiment, a computer program product to provide an audio message or a visual message to at least one participant within a plurality of participants upon joining a live teleconference or a live videoconference is provided. The computer program product may include one or more computer-readable tangible storage medium and program instructions stored on at least one of the one or more tangible storage medium, the program instructions executable by a processor. The computer program product may include program instructions to determine a critical piece of information that needs to be shared with the plurality of participants joining the live teleconference or the live videoconference, wherein the critical piece of information is associated with the live teleconference or the live videoconference. The computer program product may also include program instructions to record the critical piece of information as the audio message or the visual message in real-time during the live teleconference or the live videoconference. The computer program product may further include program instructions to replay the audio message or the visual message to the at least one participant upon the at least one participant joining the live teleconference or the live videoconference.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to one embodiment;

FIGS. 2A-2B is an operational flowchart illustrating the steps carried out by a program to provide selective teleconference or videoconference replay for future participants in a given session;

FIG. 3 is a block diagram of internal and external components of computers and servers depicted in FIG. 1 according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

Embodiments of the present invention relate to the field of computing, and more particularly to teleconferencing and videoconferencing. The following described exemplary embodiments provide a system, method and program product to, among other things, provide selective teleconference or videoconference replay for future participants in a given session.

As previously described, when a teleconference or videoconference meeting begins, critical information may be shared. However, not all attendees may be on time to the session. Therefore, the meeting may get delayed while the critical piece of information is shared over and over again as new people join the meeting, or meeting attendees may miss the important information entirely. As such, it may be advantageous, among other things, to provide a mechanism to convey the critical piece of information to the attendees of a teleconference or a videoconference while allowing participants who join the session after the information was previously shared to receive the critical piece of information as well, without disrupting the on-going activity of the session.

According to at least one implementation, a moderator associated with a teleconference and/or videoconference may press a particular key combination (e.g., *88) to begin the recording of critical information. For example, in a status call, each a participant, such as a team lead may record their status (e.g., completion status of a task, delays). Additionally, the moderator may determine when the critical replay content is complete and as such, press a particular key combination (e.g., *99) to stop the recording of critical information. Then, from this point on during the teleconference and/or videoconference, participants joining the teleconference may hear the critical piece of information.

Additionally, according to another implementation, the host of a teleconference and/or videoconference may have the capability to record a message prior to the conference beginning so that participants joining the teleconference may hear the critical piece of information. For example, a host of the teleconference and/or videoconference may realize that the e-meeting information was not included in the e-meeting invitation. Therefore, the host may press a particular key combination (e.g., *88) to begin the recording of a message. Therefore, the host may record a message such as, “Agenda didn't include the e-meeting information. Refresh the meeting invitation, or dial into conference (77333)”. Then the host may finish recording the message by pressing a particular key combination (e.g., *99) to stop the recording of the message. The teleconference and/or videoconference may continue and all participants joining the teleconference and/or videoconference may hear the message regarding the new e-meeting location.

Furthermore, according to yet another implementation a moderator for a teleconference and/or a videoconference may press a particular key combination (e.g., *88) to record a message when a teleconference and/or videoconference schedule is disrupted. For example, a teleconference and or videoconference may progress up to a certain point and then something may disrupt the schedule, such as an item on the agenda being skipped; an item on the agenda ending earlier than expected or an item on the agenda being re-scheduled for a later time. As such, the host or moderator of the meeting may press a particular key combination (e.g., *88) so that from this point on, participants joining the teleconference and/or videoconference may hear the host's or moderator's message. The message may be, for example, “We are running a little ahead of schedule. We will reconvene with agenda item “XXXX” at 1:15 pm”. Then the host or moderator may press a particular key combination (e.g., *99) to stop the recording. Therefore, the participants who hear the message may reconvene and join the teleconference and/or videoconference at 1:15 p.m. rather than unnecessarily being on the teleconference and/or videoconference. Additionally, according to one implementation, the host or moderator may press a particular key combination (e.g., *00) to stop the replay of critical information at 1:15 p.m. so that after 1:15 p.m. participants joining the teleconference will not hear any special message before joining the call. As such, the teleconference and/or videoconference may progress accordingly.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method and program product to, among other things, provide selective teleconference or videoconference replay for future participants in a given session. As previously described, the present embodiment may allow a moderator to convey critical information to the attendees of a teleconference and/or videoconference while allowing participants who join the session after the information was previously shared to receive the critical piece of information as well, without disrupting the on-going activity on the session. For example, participants may join a conference (i.e., teleconference and/or videoconference), but the moderator is not present. As such, the participants may be placed on hold. However, after the moderator starts the conference, the moderator may realize that there is critical information that everyone attending the session should know, such as critical updates from each team lead; modified e-meeting login information; or important announcements. As such, according to one implementation, the moderator may press a particular key combination that designates beginning of critical replay content (e.g., *88). Therefore, from this point on, participants joining the conference may hear (for a teleconference) or view (for a videoconference) the replay content in its entirety before joining the session. Then, the moderator may press a particular key combination that designates the end of critical replay content (e.g., *99) and the normal content of the conference may continue. As such, at any time during the conference, participants joining the session may hear or view the replay content in its entirety before joining the session.

Furthermore, according to an alternate implementation, the present embodiment may optionally allow the moderator to determine that the critical replay content is complete or no longer applicable. As such, the moderator may press a particular key combination that cancels the replay (e.g., *00). Therefore, from this point on, participants joining the conference will not hear or view any replay content before joining the session.

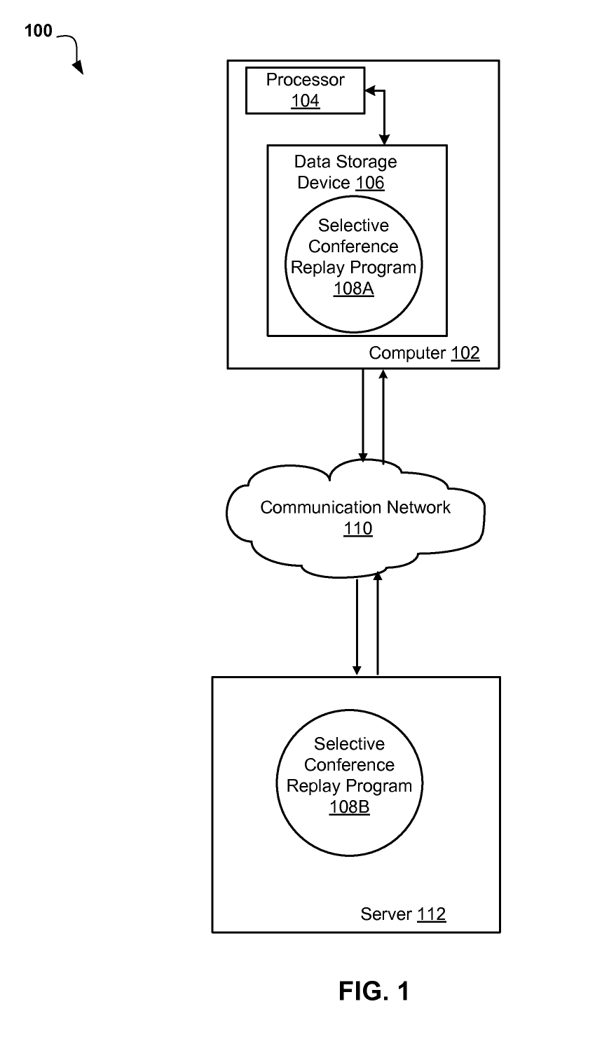

Referring now to FIG. 1, an exemplary networked computer environment 100 in accordance with one embodiment is depicted. The networked computer environment 100 may include a computer 102 with a processor 104 and a data storage device 106 that is enabled to run a Selective Conference Replay Program 108A. The networked computer environment 100 may also include a server 112 that is enabled to run a Selective Conference Replay Program 108B and a communication network 110. The networked computer environment 100 may include a plurality of computers 102 and servers 112, only one of which is shown for illustrative brevity. The communication network may include various types of communication networks, such as a wide area network (WAN), local area network (LAN), a telecommunication network, a wireless network, a public switched network and/or a satellite network. It may be appreciated that FIG. 1 provides only an illustration of one implementation and does not imply any limitations with regard to the environments in which different embodiments may be implemented. Many modifications to the depicted environments may be made based on design and implementation requirements. For example, the present embodiment may be implemented without the use of a computer, such as computer 102, for a voice only conference.

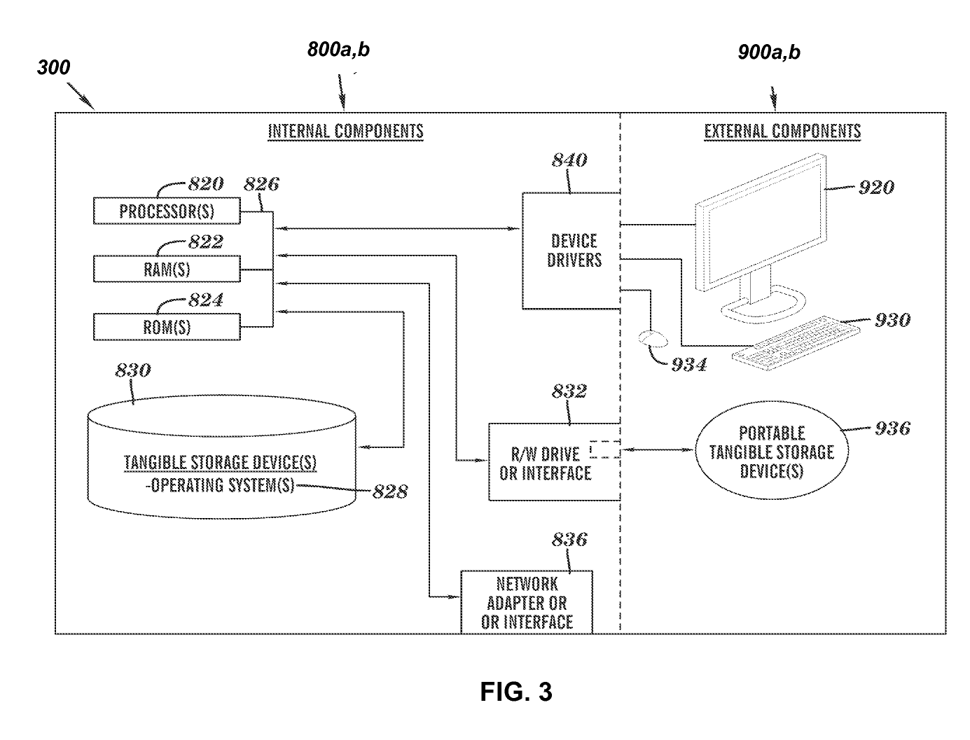

The client computer 102 may communicate with server computer 112 via the communications network 110. The communications network 110 may include connections, such as wire, wireless communication links, or fiber optic cables. As will be discussed with reference to FIG. 3, server computer 112 may include internal components 800a and external components 900a, respectively and client computer 102 may include internal components 800b and external components 900b, respectively. Client computer 102 may be, for example, a mobile device, a telephone, a personal digital assistant, a netbook, a laptop computer, a tablet computer, a desktop computer, or any type of computing device capable of running a program and accessing a network.

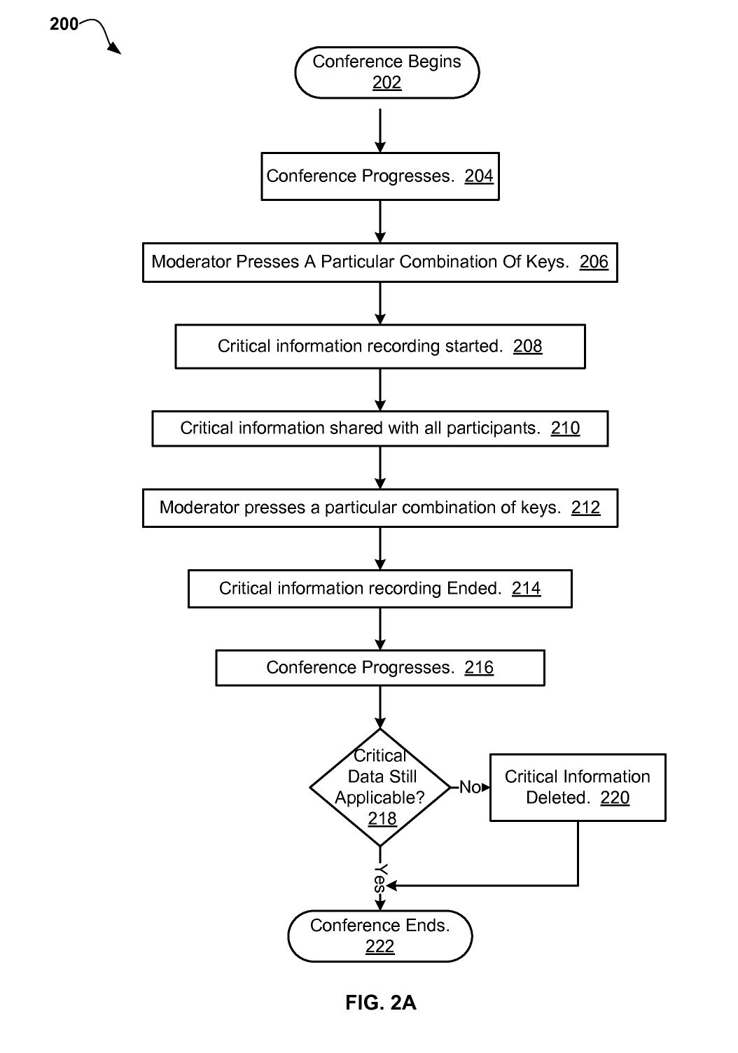

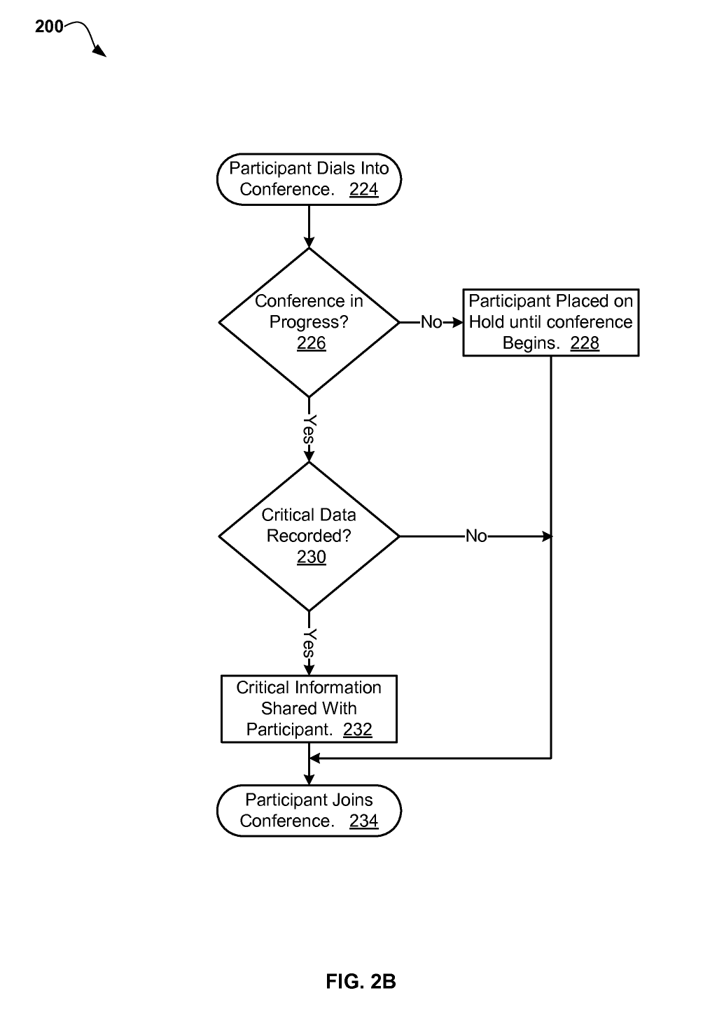

A program, such as a Selective Conference Replay Program 108A and 108B may run on the client computer 102 or on the server computer 112. The Selective Conference Replay Program 108A, 108B may convey critical information to attendees of a teleconference or videoconference while allowing participants who join the session after the information was previously shared to receive the critical piece of information as well, without disrupting the on-going activity of the session. The Selective Conference Replay method is explained in further detail below with respect to FIGS. 2A-2B.

Referring now to FIGS. 2A-2B, an operational flowchart 200 illustrating the steps carried out by a program to provide selective teleconference or videoconference replay for future participants in a given session in accordance with at least one embodiment is depicted. For example, the Selective Conference Replay Program 108A, 108B (FIG. 1) may be implemented as running on a client computer 102 (FIG. 1) or server computer 112 (FIG. 1). As previously described, a user using client computer 102 (FIG. 1) or server computer 112 (FIG. 1) may execute the Selective Conference Replay Program 108A, 108B (FIG. 1) to convey critical information to attendees of a teleconference or videoconference while allowing participants who join the session after the information was previously shared to receive the critical piece of information as well, without disrupting the on-going activity of the session.

With respect to FIG. 2A at 202, a conference begins. According to the present embodiment, the conference may be a teleconference and/or a videoconference. The participants may join the conference; however, if the moderator is not present, the participants may be placed on hold.

Then at 204, the conference progresses. As such, the moderator may join and the conference may progress. Next at 206, the moderator presses a particular combination of keys to record critical information. As such, once the conference begins, it may be determined that there is critical information that everyone attending the conference session should know. For example, critical information may include critical updates from each team lead, modified e-meeting login information; or important announcements. According to one implementation, the moderator may press a particular key combination (e.g., *88) that designates the beginning of critical replay content.

Next at 208, the critical piece of information recording is started. As such, the critical piece of information may be recorded so that the critical piece of information may be shared with future participants joining the conference.

Then at 210, the critical piece of information is shared with all the participants. As such, according to at least one implementation of the present embodiment, participants joining the conference may all hear (for a teleconference) or view (for a videoconference) the replay content (that was previously recorded in step 208) in its entirety before joining the session.

Next at 212, the moderator presses a particular combination of keys to designate the end of the critical replay content. For example, the moderator may press a particular key combination (e.g., *99) to designate the end of the critical replay content.

Then at 214, the critical piece of information recording is ended. Next at 216, the conference progresses. As such, the normal “body” of the conference may continue to progress following the recording of the critical piece of information.

Next at 218, it is determined whether the critical data is still applicable. For example, the critical piece of information message may pertain to the meeting reconvening at a particular time of the day and therefore, the message may no longer be applicable after that particular time of the day. As such, the moderator may determine that the critical replay content is no longer applicable. Therefore, if at 218, it is determined that the critical data is not applicable, then at 220 the critical piece of information may be deleted. According to one implementation, the moderator may press a key combination (e.g., *00) that may cancel the replay of the critical piece of information. As such, the participants joining the conference after the critical piece of information has been deleted may not hear or view any replay content before joining the session until the conference ends at step 222. However, if at 218, it is determined that the critical data is applicable, then participants joining the conference may continue to hear or view any replay content before joining the session until the conference ends at 222.

With respect to FIG. 2B at 224, a participant may dial into a conference. Then at 226, it may be determined whether the conference is in progress. If at 226, it is determined that the conference is not in progress then at 228, the participant may be placed on hold until the conference begins (e.g., the moderator has not joined the conference yet). Next at 234, the participant may join the conference once it begins (e.g., the moderator has joined and started the conference). However, if at 226, it is determined that the conference is in progress, then at 230, it may be determined whether there is any critical data (i.e., critical replay content or information) that has been recorded. If at 230, it is determined that there is critical data to be shared with the participant, then at 232, the critical piece of information may be shared with the participant. Next at 234, the participant may join the conference once the critical piece of information has been heard or viewed by the participant. However, if at 230, it is determined that there is not any critical data to be shared with the participant, then at 234, the participant may join the conference.

It may be appreciated that FIGS. 2A-2B provide only an illustration of one implementation and does not imply any limitations with regard to how different embodiments may be implemented. Many modifications to the depicted environments may be made based on design and implementation requirements. Implementations of the present embodiment may capture the customization and changes, performed by skilled administrators, to an initial software product installation and configuration script together with knowledge gained and associated with it.

Implementations of the present embodiment may allow critical information to be heard or viewed by all current and future teleconference or videoconference participants. Furthermore, the present embodiment may save time of participants attending a meeting (i.e., a session), as the meeting is not interrupted to repeat information numerous times as new participants join. For example, repeating a 30-second announcement to one person in a conference attended by 30 people may result in the loss of 15 minutes worth of time, in addition to the cost of the context switch (i.e., total cost=(# of times repeated*length of message*number of attendees)). Also, according to at least one implementation, critical content may be contributed by multiple meeting participants and the recording of the critical piece of information may be performed once, live, in real-time during the conference session. Additionally, a teleconference or videoconference moderator may not have to wait unnecessarily to inform all of the participants that the meeting will reconvene when there is down time during the conference.

FIG. 3 is a block diagram 300 of internal and external components of computers depicted in FIG. 1 in accordance with an illustrative embodiment of the present invention. It should be appreciated that FIG. 3 provides only an illustration of one implementation and does not imply any limitations with regard to the environments in which different embodiments may be implemented. Many modifications to the depicted environments may be made based on design and implementation requirements.

Data processing system 800, 900 is representative of any electronic device capable of executing machine-readable program instructions. Data processing system 800, 900 may be representative of a smart phone, a computer system, PDA, or other electronic devices. Examples of computing systems, environments, and/or configurations that may represented by data processing system 800, 900 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 (FIG. 1), and network server 112 (FIG. 1) may include respective sets of internal components 800a, b and external components 900a, b illustrated in FIG. 3. Each of the sets of internal components 800a, b includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828 and Selective Conference Replay Program 108A (FIG. 1) in client computer 102 (FIG. 1) and Selective Conference Replay Program 108B (FIG. 1) in network server computer 112 (FIG. 1) are stored on one or more of the respective computer-readable tangible storage devices 830 for execution by one or more of the respective processors 820 via one or more of the respective RAMs 822 (which typically include cache memory). In the embodiment illustrated in FIG. 3, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800a, b, also includes a R/W drive or interface 832 to read from and write to one or more portable computer-readable tangible storage devices 936 such as a CD-ROM, DVD, memory stick, magnetic tape, magnetic disk, optical disk or semiconductor storage device. A software program, such as Selective Conference Replay Program 108A (FIG. 1) and 108B (FIG. 1), can be stored on one or more of the respective portable computer-readable tangible storage devices 936, read via the respective R/W drive or interface 832 and loaded into the respective hard drive 830.

Each set of internal components 800a, b also includes network adapters or interfaces 836 such as a TCP/IP adapter cards, wireless Wi-Fi interface cards, or 3G or 4G wireless interface cards or other wired or wireless communication links. The Selective Conference Replay Program 108A (FIG. 1) in client computer 102 (FIG. 1)and Selective Conference Replay Program 108B (FIG. 1) in network server 112 (FIG. 1) can be downloaded to client computer 102 (FIG. 1) from an external computer via a network (for example, the Internet, a local area network or other, wide area network) and respective network adapters or interfaces 836. From the network adapters or interfaces 836, the Selective Conference Replay Program 108A (FIG. 1) in client computer 102 (FIG. 1) and the Selective Conference Replay Program 108B (FIG. 1) in network server computer 112 (FIG. 1) are loaded into the respective hard drive 830. The network may comprise copper wires, optical fibers, wireless transmission, routers, firewalls, switches, gateway computers and/or edge servers.

Each of the sets of external components 900a, b can include a computer display monitor 920, a keyboard 930, and a computer mouse 934. External components 900a, b can also include touch screens, virtual keyboards, touch pads, pointing devices, and other human interface devices. Each of the sets of internal components 800a, b also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method to provide an audio message or a visual message to at least one participant within a plurality of participants upon joining a live teleconference or a live videoconference, the method comprising:
determining a critical piece of information that needs to be shared with the plurality of participants joining the live teleconference or the live videoconference, wherein the critical piece of information is associated with the live teleconference or the live videoconference;
recording the critical piece of information as the audio message or the visual message in real-time during the live teleconference or the live videoconference; and
replaying the audio message or the visual message to the at least one participant upon the at least one participant joining the live teleconference or the live videoconference.

2. The method of claim 1, further comprising:
inputting a first key combination to begin the recording;
inputting a second key combination to end the recording; and
inputting a third key combination to delete the recording.

3. The method of claim 1, further comprising:
determining whether the audio message or the visual message is still applicable;
and
deleting the audio message or the visual message based on the determining whether the audio message or the visual message is still applicable.

4. The method of claim 1, wherein the replaying the audio message or the visual message comprises a determination as to whether there is a recording upon the at least one participant joining the live teleconference or the live videoconference.

5. The method of claim 1, wherein the replaying the audio message or the visual message comprises a determination as to whether the live teleconference or the live videoconference has started.

6. The method of claim 1, wherein the replaying of the audio message or the visual message to the at least one participant upon joining the live teleconference or the live videoconference does not interrupt the live teleconference or the live videoconference.

7. The method of claim 1, wherein the recording of the critical piece of information as the audio message or the visual message during the live teleconference or the live videoconference is performed one time by at least one participant within the plurality of participants during the live teleconference or the live videoconference.
